(19) United States
(12) Patent Application Publication
(10) Pub. No.: US 2004/0124652 A1
(43) Pub. Date: Jul. 1, 2004

(54) Motorcycle accessory

(76) Inventor: John Michael Garrison, Littleton, CO (US)

Correspondence Address: SHERIDAN ROSS PC, 1560 BROADWAY, SUITE 1200, DENVER, CO, 80202

(21) Appl. No.: 10/642,378

(22) Filed: Aug. 14, 2003

Related U.S. Application Data
(60) Provisional application No. 60/404,114, filed on Aug. 15, 2002.

(51) Int. Cl. B60R 9/00

(52) U.S. Cl. 296/37.1

(57) ABSTRACT

A motorcycle assembly affords a motorcycle rider with the easy accessibility to various personal items. A substantially planar structure is affixed either to a windshield support structure or to a rider's handlebars, such planar structure having at least one cup holder and at least one compartment, preferably a covered and latchable/lockable compartment, to facilitate storage of a rider's personal items.

### FIELD OF THE INVENTION

The present invention is directed to a motorcycle accessory, and in particular, to an accessory mountable to a motorcycle to facilitate the containment of various personal items such as beverage containers, sunglasses, cell phones, etc.

### BACKGROUND OF THE INVENTION

In contrast to the various creature comforts available to passengers inside an automobile, motorcycle riders have not been afforded such conveniences. For example, given the physical constraints on a motorcycle, there is limited space for storing personal items. Easily accessible cup holders/beverage containing holders have not been provided for, thus requiring motorcycle riders to store personal items in pockets and/or to precariously hold such items while attempting to operate the motorcycle with one hand. There is therefore a long felt but unsolved need for a simple, relatively inexpensive motorcycle accessory that affords a rider the ability to store personal items, as well as beverage containers, etc., in a readily accessible place so that such items can be retrieved during normal operation of the motorcycle.

### SUMMARY OF THE INVENTION

While not limiting the present invention to particular embodiments disclosed in this summary, the present invention is generally directed to an accessory that can either be permanently and/or reversibly affixed to a motorcycle so as to afford a motorcycle rider with relatively ready accessability to compartments in which personal items can be stored. In other embodiments, at least one cup holding device is provided. In a preferred embodiment, the motorcycle accessory is reversibly mounted in front of the motorcycle handles bars and directly behind the motorcycle windshield. In this position, a motorcycle rider can access a cup holder and/or storage compartment for personal items without requiring that his attention and high contact is substantially diverted from the riding operation.

Various configurations of particular structural features of the accessory that accommodate particular desires of a rider are within the scope of the present invention. For example, in one embodiment, a single cup holder is provided for the rider and adjacent thereto is a compartment, preferably with a spring latched cover, within which personal items, such as sunglasses, cell phones, cigarettes, etc., can be stored. More than one beverage container holder, however, can be provided for and more than one type of storage compartment can be provided, including open as well as closeable storage compartments for containing miscellaneous items. Moreover, the motorcycle accessory of the present invention can further include hooks or clips and/or apertures through which various other items can be attached and/or suspended from the motorcycle accessory. In a preferred embodiment, a compartment is provided that has a locking device that is lockable by the rider in order to provide a secure place in which to maintain personal items. In still other embodiments, an air bag can be mounted on or adjacent to the motorcycle accessory in order to provide the safety features offered by an air bag.

In one embodiment, the motorcycle accessory is reversibly detachable from a motorcycle windshield mounting structure, for example, by pressing on disconnect buttons, or other slideable engagement mechanisms, etc. The motorcycle accessory of the present invention can also be provided with various useful features, such as a compass, a clock, a compartment for a garage opener and/or for electronic controls to operate a garage opener, a global positioning system, etc. Still further embodiments include compartments to hold music CDs and/or tapes or other music playing devices or paraphernalia.

Other advantages and embodiments of the present invention are discussed in the detailed description set forth below as well as depicted in the figures.

### BRIEF DESCRIPTION OF THE DRAWINGS

FIG. 1 shows one embodiment of the present invention affixed to a motorcycle on the riders side of the motorcycle windshield;

FIG. 2 shows another perspective of the present invention mounted to a motorcycle;

FIG. 3 is a perspective view of one embodiment of the present invention showing a cup holder and a covered compartment;

FIG. 4 shows the embodiment shown in FIG. 3 with the cover open showing a duo-compartment;

FIG. 5 is a side view of the embodiment of FIG. 3.

### DETAILED DESCRIPTION

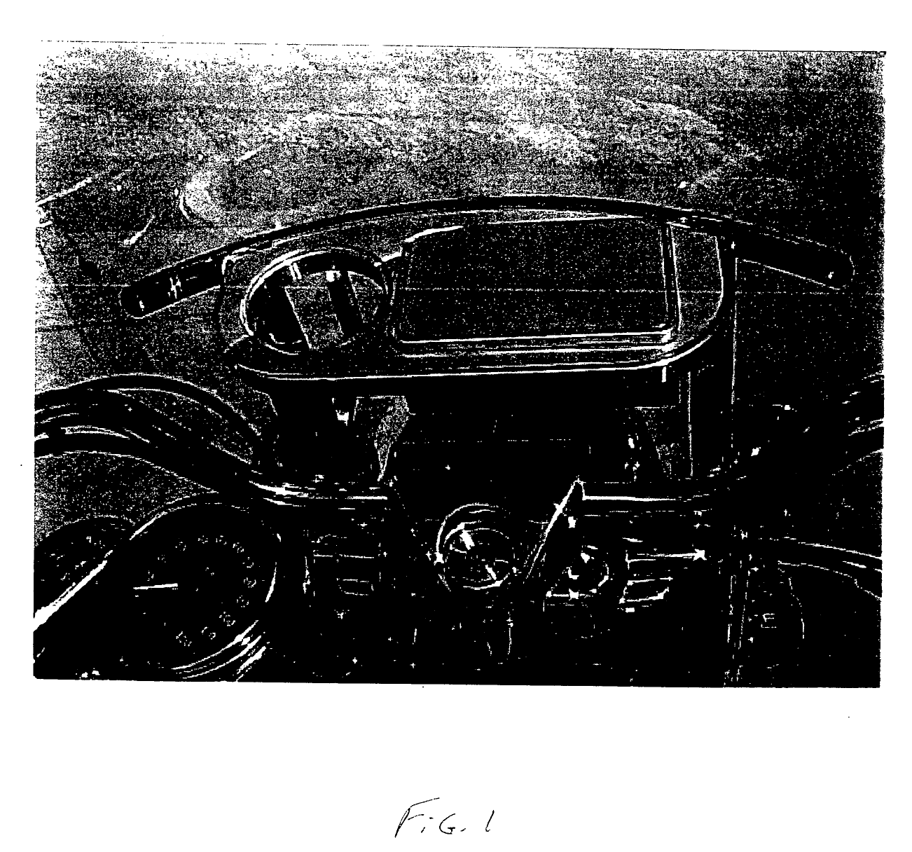

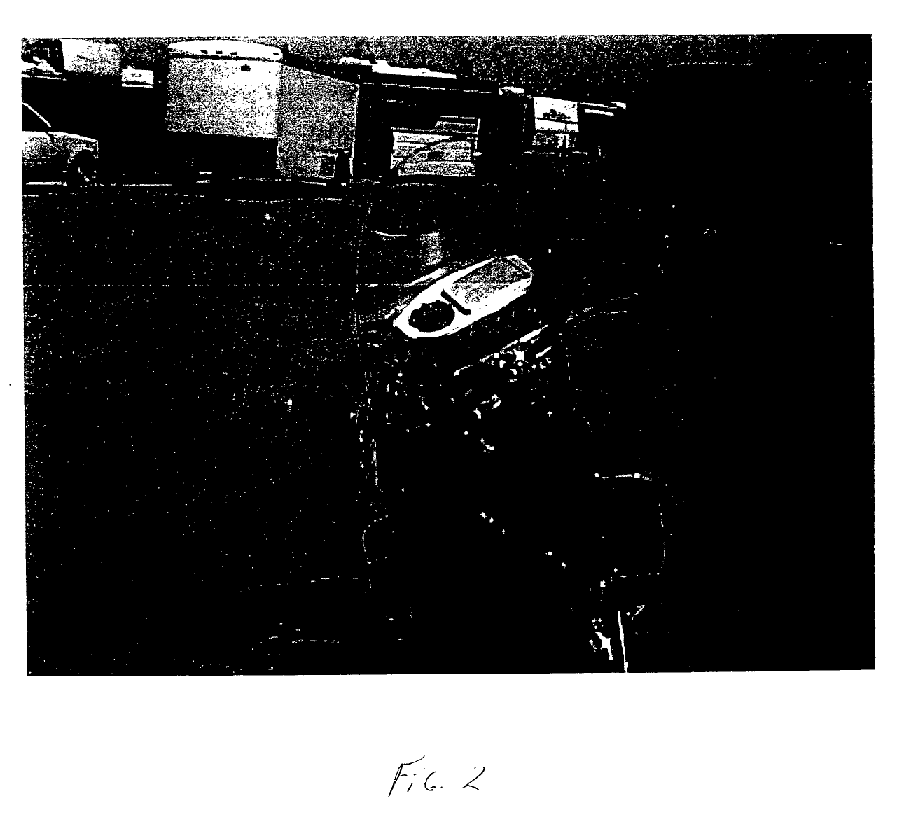

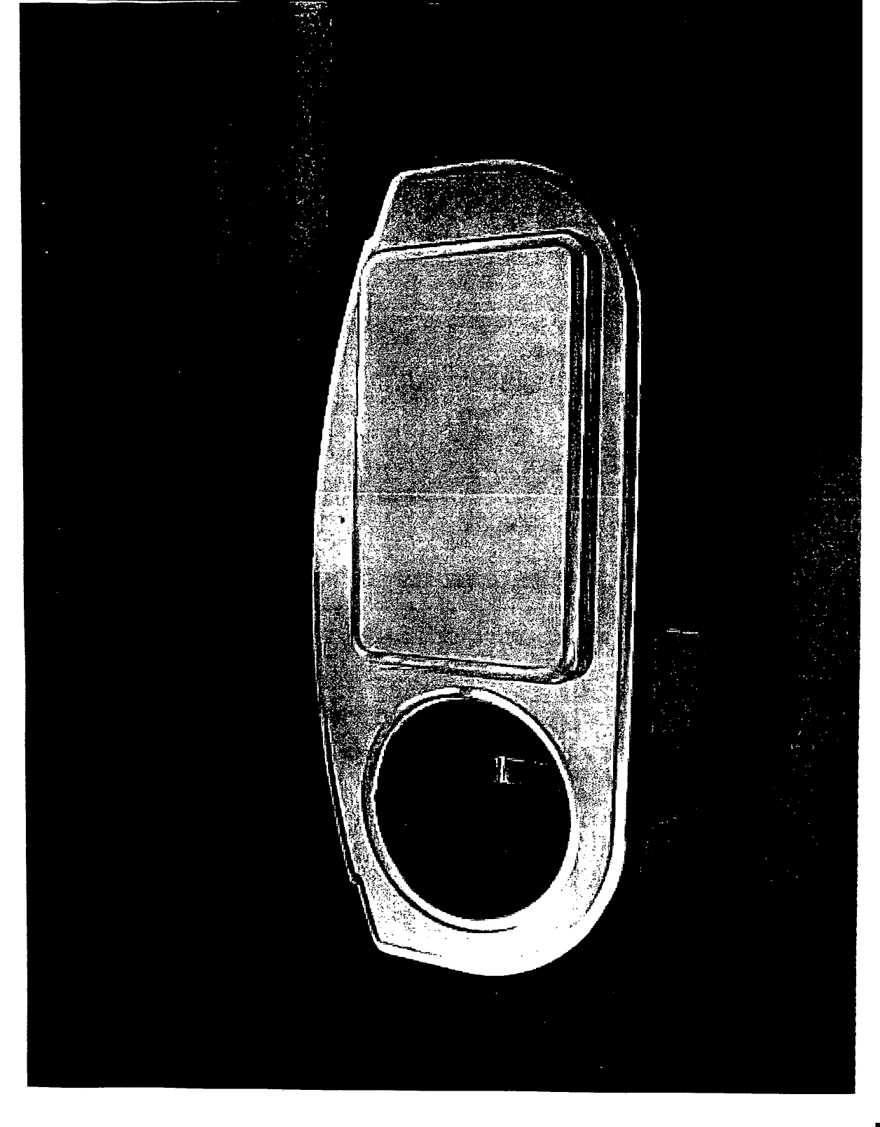

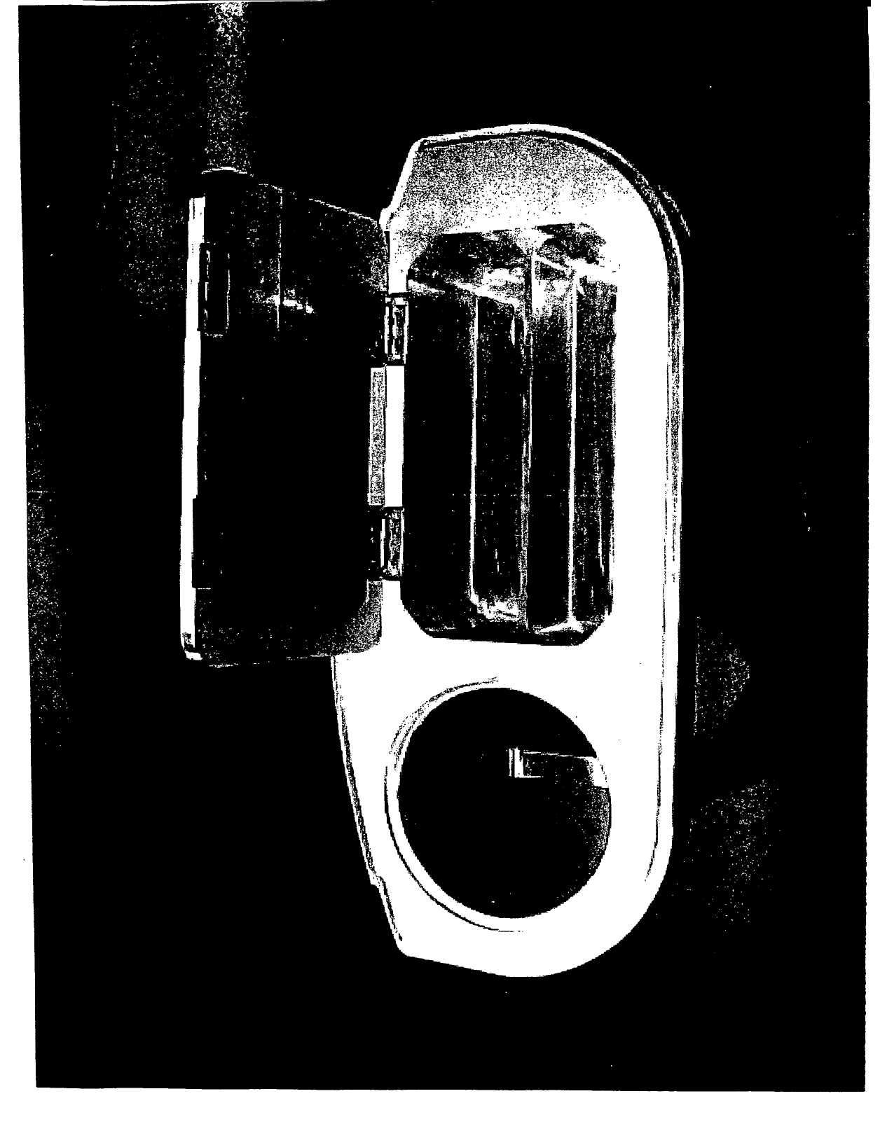

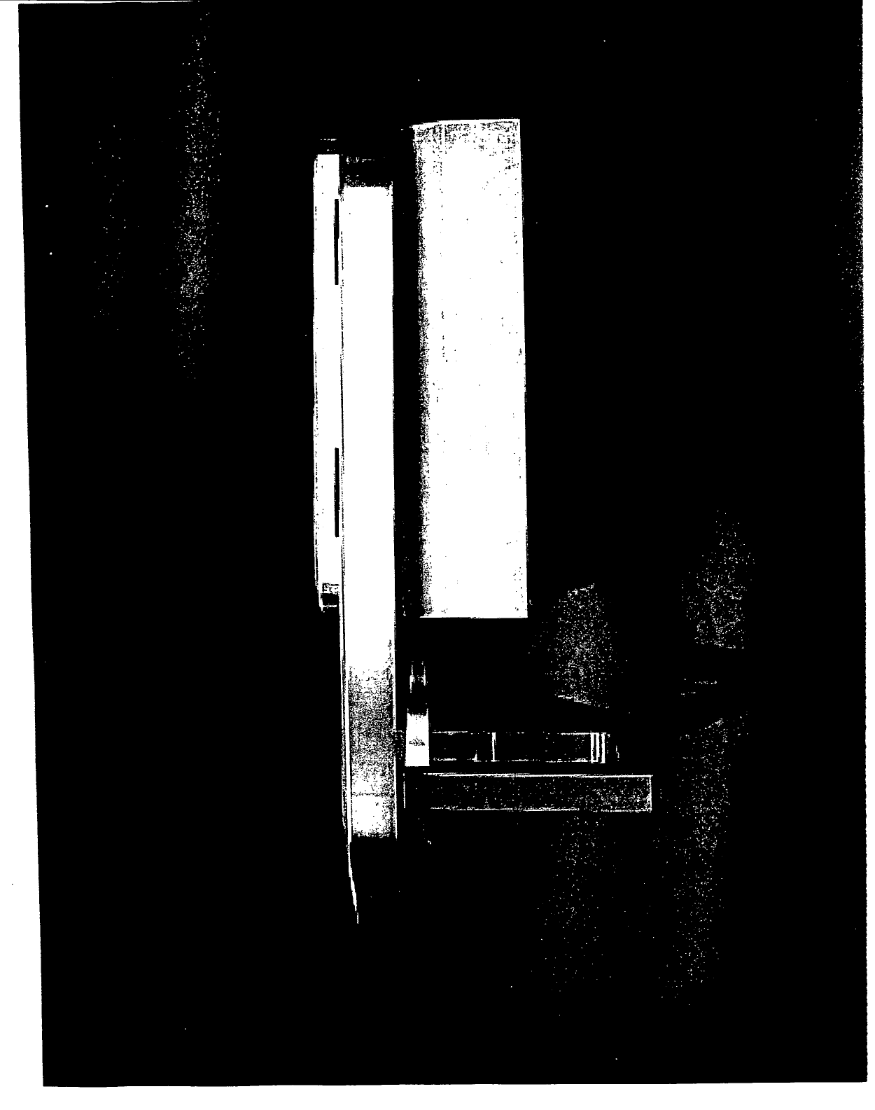

In one embodiment, pictured in FIGS. 1-5, the present invention comprises a structural platform that can accommodate storage of various personal items, including beverage containers, cups, sunglasses, cell phones, cigarettes, etc. The present motorcycle assembly 10 is preferably configured so as to fit within the space between a motorcycle's handle bars 12 and a motorcycle's windshield 14. A relatively planar portion 16 is provided with attachment means 18 (which can involve either permanent affixation devices such as screws, welds, adhesives, etc., or alternatively, can comprise reversibly attachable mechanisms, such as push button disconnecting mechanisms, engageable sliding members, and other attachment mechanisms that will be appreciated by one of skill in the art). In a preferred embodiment, a cup holder 20 is provided for, such cup holder preferably having descending structural supports 22 to support any beverage container and/or cup that may be placed within the cup holder 20. The planar portion 16 can also accommodate or be provided with a compartment 24 which is preferably operatively associated with a cover 26. The cover 26 can be a simple hinged design, or alternatively, can be of various other configurations, for example, a roll top design having accordion-like and/or blind-like overlapping members (so that a rider can slide the cover into an open and/or closed position). In the embodiment shown in FIG. 4, a hinged cover is provided. Preferably, the hinged cover is biased by springs so as to maintain the cover in an open position unless latched to a closed position. In this way, any wind turbulence will not force the cover into a closed position unless the rider wishes the cover to be closed. Any suitable latch mechanism (not shown) can be used for such cover. Indeed, in a preferred embodiment, the cover is capable of being locked so as to secure the contents therein. Any suitable locking mechanism can be utilized for such purpose (e.g., a key lock, electronic lock, combination lock, etc.).

The particular dimensions of the motorcycle assembly 10 of the present invention can be varied to accommodate the particular desires and needs of a motorcycle rider. For example, more than one cup holder 20 can be provided for, for example, on each side of the storage compartment 24. The planar portion 16 is preferably designed so as to permit the rider to have a substantially unobstructed view of the roadway in front of him and to permit a rider to view the front of his/her bike, and thus, the size and/or shape of the planar platform 16 is preferably designed so as to achieve this objective. In other embodiments, however, the planar platform 16 can be expanded in width and length, as well as depth, to accommodate particular uses and to afford more space in which to store and/or maintain particular items that may be used by a motorcycle rider.

Although the present invention is shown in the figures as being utilized with a motorcycle having a windshield associated therewith, it is possible to utilize the present invention in other motorcycle embodiments that do not have a fixed windshield associated therewith. In such circumstances, a mounting device either to the handle bars 12 and/or associated with the frame of the bike, can be utilized.

In a preferred embodiment, the depth of the compartment 24 is approximately 4-5 inches but may be as deep as the particular motorcycle bike configuration affords without any stearic hindrance of the steering operation. The compartment itself can be one undivided compartment, or alternatively, can be provided with various dividers in order to accommodate the storage and separation of particular items. The compartment can be lined with fabric, rubber, plastic or other materials that may reduce the chattering or physical contact between personal items placed in such compartment when the motorcycle is in operation. Coin compartments, sunglass holding compartment means, cell phone attachment mechanisms, cigarette/cigar holders, as well as cigarette lighter holding portions, etc., can be provided in or around the compartment 24. Preferably, the compartment has at least two separate areas within which to store material sessions of the rider.

As will be appreciated, various different designs of cup holders 20 can be utilized, rather than the ones pictured in FIGS. 1-5. For example, various pivotable mounting cup holders can be utilized to accommodate the vibrational forces experienced during the motorcycle operation, as well as to accommodate the angular adjustment of the bike when in operation. Various cup holding devices of such a pivotable mount are known such that the liquid in a container is maintained at a substantially level orientation with respect to the ground regardless of the angle of the bike and/or planar portion 16.

In terms of construction, the present invention 10 can be made of any suitable material, and preferably is manufactured from durable plastic material, wood, composite material and/or metal material. Various cosmetically pleasing surfaces and/or materials can be used in constructing the present invention 10, such that chrome plated materials, brushed steel, wood grain, etc., can be provided for on the surfaces of the present invention 10 to accommodate particular desires of a rider. In one embodiment, the entire motorcycle assembly 10 is manufactured from metal. In other embodiments, the compartment 24 and the structural supports 22 for the cup holder 20 are manufactured from a hardened plastic material, with the surface of the planar portion 16 manufactured from metal. While weight characteristics of the present invention 10 are not deemed to be that important, the device 10 can obviously be manufactured from light weight materials in order to lessen the total weight of the motorcycle accessory.

As may also be appreciated by one of skill in the art, the motorcycle accessory of the present invention can also be mounted at various other places on a motorcycle, for example, on the crash bar near the rear of the motorcycle. In such case, a second passenger behind the motorcycle rider steering the vehicle, can have access to a personal storage compartment/cup holder device.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. A motorcycle accessory, comprising a planar portion having at least one aperture dimensioned suitable to hold a beverage container and at least one compartment having a cover operatively associated said compartment, said planar portion connectable to a motorcycle and positioned forward of a motorcycle's handlebars.
